(19) United States
(12) Patent Application Publication
(10) Pub. No.: US 2011/0173153 A1
(43) Pub. Date: Jul. 14, 2011

(54) Method and apparatus to import unstructured content into a content management system

(75) Inventors: Michael Domashchenko, Lilburn, GA (US); Edward B. Heinz, Loganville, GA (US)

(73) Assignee: VERTAFORE, INC.

(21) Appl. No.: 12/654,932

(22) Filed: Jan. 8, 2010

(51) Int. Cl. G06F 17/00

(52) U.S. Cl. 707/608; 707/741; 707/753; 707/E17.083; 707/E17.005

(57) ABSTRACT

A content management system having a repository of information organized according to an index file, a method of importing unstructured content comprising an XML or other template of configurable import rules to enable retrieval of information components of the unstructured content; ascertaining at least one structural attribute of the unstructured content; enabling a user to configure import rules according to the ascertained structural attribute(s); accessing and examining information components of the unstructured content according to the attribute(s); optionally tagging information components of the unstructured content according to a value of the accessed and examined information components; importing information components of the unstructured content into a repository of the content management system according to indices of the index file; identifying a workflow task with respect to the information components of the imported content; and processing a workflow task of the content management system relative to the imported content.

### BACKGROUND

This invention relates to content or document management, but more specifically to a content manage system and method in which unstructured content may be imported into the system for routine workflow processing.

Many enterprise organizations, such as financial and insurance companies, utilize automated workflow management (WM) systems and methods to process documents, images, multimedia, or other information (hereafter referred to as content). For an insurance company, information processed by automated workflow operations may include insurance claims, issuances of new policies, coverage adjustments, and updating of customer accounts. In doing so, such information is typically imported into the system but the importation task may become challenging when the information resides in an unstructured file format or structure. Volumes of content information obtained from multiple branch offices of an organization are usually batch-processed at a central processing center so the task acquiring information into the automated workflow system could become insurmountable when attempting to import and process unstructured content.

Accordingly, it is desirable to provide a business or other enterprise with the flexibility to support unstructured or complex file structures when importing content into a content management system for automated workflow processing. Further, it is desirable to add this flexibility to an existing import process of a content management system by associating the unstructured content or file to be imported with user-configurable importation rules.

### SUMMARY

The present invention, which we call Universal Imports, allows a user to import unstructured content with limited information about its data structure, to use the limited information to derive more detailed information about the place to store components of the unstructured content in the management system, to store the unstructured content in the management system using information provided by importation rules, to tag the imported content with additional indices for subsequent access and processing, and to create a work item for subsequent automated workflow processing with respect to the imported content.

According to the present invention, a business enterprise advantageously may build import rules to fit a specific importation need instead of being required to follow a rigid set of rules like in previous implementations. Formatting rules, for example, of an index file approximating the format of the unstructured content may be configurable to facilitate the importation process. In addition, unlike previous import methods and systems, the present invention supports complex file structures like nested folders and attributes at any level. Previous methods and systems also did not support task/diaries at any level of automated content processing or a lookup/update ability. On the other hand, the present invention allows an enterprise to import large volumes of unstructured data into a content management system that may require a complex list of rules and/or file structure.

According to a first aspect of the present invention, there is provided in a content management system having a repository of information organized according to an index file, an improvement comprising a method of importing unstructured content into the repository which includes providing a template (e.g., an XML template) of configurable import rules to enable retrieval of information components of the unstructured content; ascertaining at least one a structural attribute of the unstructured content; enabling a user to configure import rules of the template according to the ascertained structural attribute(s); accessing and examining information components of the unstructured content according to the attribute(s); optionally tagging information components of the unstructured content according to a value of the accessed and examined information components; importing information components of the unstructured content into the repository of the content management system according to indices of the index file; identifying a workflow task with respect to the information components of the imported content; and processing a workflow task of the content management system relative to the imported content.

Other aspects of the method include iteratively defining import rules for the unstructured content according to structural information learned in a prior importation step in order to refine or make more definite the import rules, and associating information components of the unstructured content with respective indices of the index file prior to importing components of the unstructured content into the repository.

In accordance with another aspect of the invention, there is provided in a content management system a method of importing unstructured content comprising establishing indexing criteria for use in the content management system wherein the indexing criteria are defined to support a workflow processing scheme; examining the unstructured content to determine a preliminary file structure; providing a template of user-configurable import rules; configuring the import rules of the template according to the preliminary file structure of the unstructured content; importing the content into the content management system according to the import rules; and performing a workflow task with respect to the imported content. Additional aspects include the steps of providing a record for each page in a records database used to store retrieve pages of information of the unstructured content, and indexing each page of the imported content to provide a reference useful to retrieve each page in the content management system.

In yet another aspect of the invention, there is provides a content management system useful for importing unstructured content wherein the system comprises a template of configurable import rules; a user interface module to provide a user interface that enables a user to configure the template; a repository to store information; a retrieval module to access and retrieve information components from a storage medium containing the unstructured content where the accessing and retrieval are performed according to the template of configurable import rules; an indexing module responsive to the retrieval module to store information components of the unstructured content in the repository according to indices of an index file; and a workflow processing module that accesses the repository to process information components of the imported, unstructured content.

The system may further include a tagging module responsive to the retrieval module to tag respective information components of the unstructured content according to a value thereof, wherein the indexing module effects storage of the components in the repository according to the tag. Information components may be tagged according to a field reference value or a literal value, and the retrieval module may retrieve information components of the unstructured content according to a data field of a record and/or a delimiter of the unstructured content. In addition, the user interface module may enable the user to iteratively reconfigure the import rules of the template based on the nature or character of imported records of the unstructured content observed during a prior importation. In addition, the user interface module may enable the user to reconfigure indices of the index file in order to alter the structure of the repository in which information components of the unstructured content are stored.

Other aspects of the invention will become apparent upon review of the following description taken in connection with the accompanying drawings. The invention, though, is pointed out with particularity by the appended claims.

### BRIEF DESCRIPTION OF THE DRAWINGS

FIG. 1 depicts a block diagram arrangement of an exemplary multi-user content management system in which the invention may be implemented.

FIG. 2 shows an exemplary method, according to the present invention, that may be implemented in the content management system of FIG. 1.

FIG. 3 shows an example of an XML template that defines import rules according to an aspect of the present invention.

FIG. 4 illustrates defining an import rule for fixed width components having an offset or starting position and having a length.

FIG. 5 illustrates defining an import rule having a delimiter separating components of the unstructured content.

FIG. 6 shows the table of named fields which may be referenced in an XML template that defines import rules according to an aspect of the present invention.

### DESCRIPTION OF ILLUSTRATIVE EMBODIMENTS

Universal Imports advantageously provides a user with the ability to create file structure, to create/update files and file attributes, to create/update folders and folder attributes, to create/update documents and document attributes, to create pages, to create/update tasks and task attributes at any level, to create/update task notes, to create diaries at any level, to import into nested or repeatable folders, to add documents to any folder, to add pages to any document, and to add/remove file marks and add page marks. In practice, the Universal Imports is implemented in an ImageRight Content Management and Workflow Management System that is specially designed for the insurance and financial companies, which system and software are commercially available from Vertafore, Inc. of Bothell, Wash.

A list of configurable importation rules in an XML template provides the primary tool used to accomplish the flexibility of the present invention. The template allows a workflow administrator or other user to define a set of rules that dictate where the import process obtains the unstructured information and how users of the content management system will work with that information. The template follows the XML specifications described by w3c (http://www.w3.org/XML/).

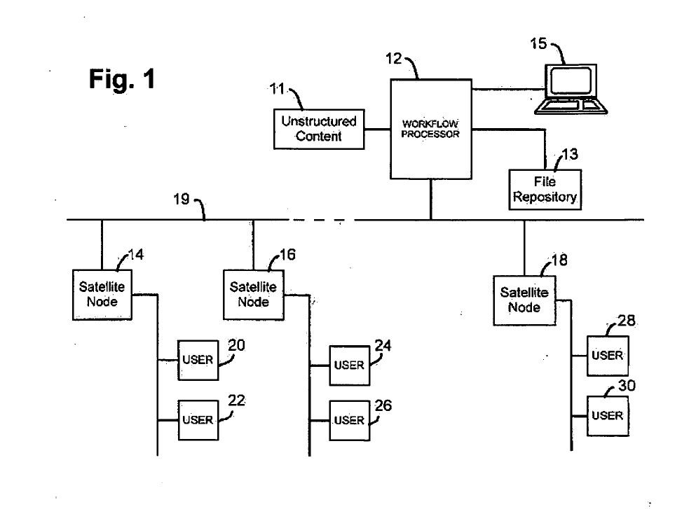

FIG. 1 depicts a block diagram arrangement of an exemplary multi-user content management system 10 in which Universal Imports may be implemented. System 10 is configured to manage or maintain files and/or work items to be processed by a user, such as a workflow administrator, and includes a workflow processor 12 situated at a central location of an enterprise and one or more satellite nodes 14, 16, and 18 that respectively reside at branch offices of the enterprise. The central location includes a repository 13 to store content for automated workflow processing, a user terminal 15 providing an interface to receive instructions from a user, and a storage medium 11 from which unstructured content may be imported into the system 10. Although illustrated as separate storage elements or modules, functions carried out by elements of system 10 may reside in one or more software or hardware modules or be integrated within a single hardware or software module. In addition, the workflow processor 12 includes a number of executable program modules including a retrieval module to access and retrieve information components from the storage medium 11 containing the unstructured content; an indexing module responsive to the retrieval module to store information components of the unstructured content in the repository 13 according to indices of an index file; and a workflow processing module that accesses the repository to process information components of imported, unstructured content according to a workflow task defined by a user. Functions performed at the central location may also be carried out at a satellite node.

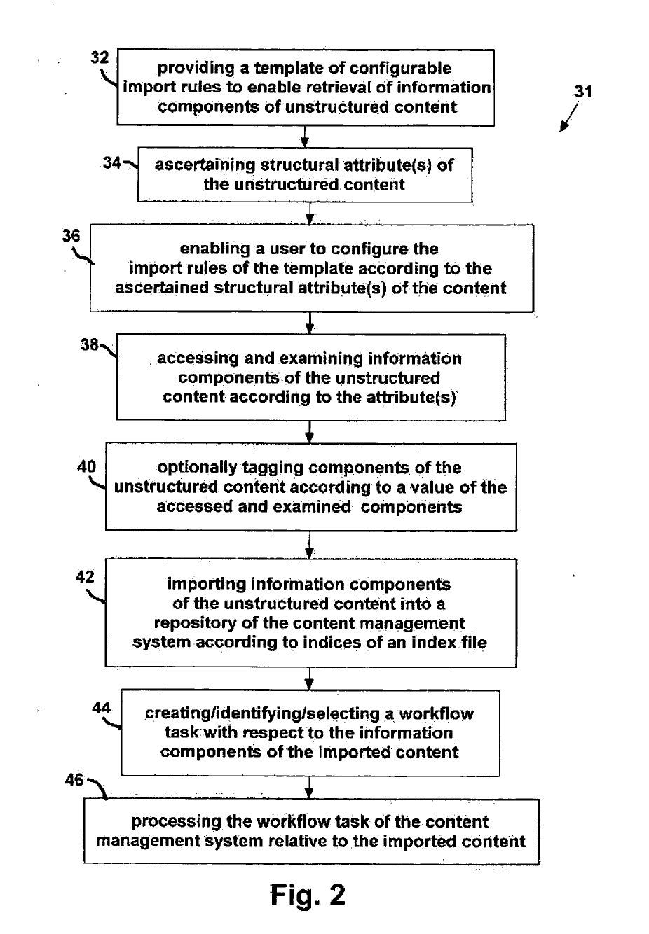

Satellite nodes 14, 16, and 18 serve respective users 20, 22, 24, 26, 28, 30 of the remote satellite offices where human users may also process files, import content, or perform work assignments. Each of the nodes 12, 14, 16, and 18 may include data processing devices or servers that manage, store, and/or effect transfer of files and other information locally or remotely via a network 19, as well as a user interface (e.g., display, keyboard, mouse, etc.) to enable a user to communicate with the system. These nodes also generate graphical user interfaces on a display device, subsequently described, that enable users to define or dynamically define processing parameters for performing a principal workflow task and various subtasks thereof. In particular, processors at one or more of the nodes 12, 14, 16, and 18 include executable program modules to implement the process steps set forth in FIG. 2 to enable a user such as a task manager, workflow administrator, and/or employee of an enterprise to interact with system 10. Network 19 may comprise wired or wireless links with the nodes, e.g., via a LAN, WAN, WiFi, Internet, or other communication protocol using conventional interfaces and communication standards.

FIG. 2 shows an exemplary process 31 that may be implemented in content management system 10 of FIG. 1. In the management system, repository 13 contains information organized according to an index file to enable information storage and retrieval during for workflow processing. The improvement provided by Universal Imports comprises a method of importing unstructured content from medium 11 into repository 13 for such automated workflow processing.

To begin, method 31 of FIG. 2 comprises a step 32 of providing an XML or other template (subsequently described) of configurable import rules to enable retrieval of information components of unstructured content, and a step 34 of ascertaining at least one structural attribute of the unstructured content. A structural attribute, for example, may include a field value of a record or a delimiter that separates values within a data string. An example of unstructured content includes images, such as photographs. A photographic image data by itself does not possess any structure, per se. An example of structured data might include insurance policy information, such as policy number, policyholder name, etc. Policy information is usually sufficiently definitive to provide instructions on how to locate that file within an unstructured storage facility.

Universal Imports allow a user to examine existing structure based on one or more attributes of that structure. The lookup rules may contain only that which is needed to find the structure. An example may be an attribute on a policy folder called CLAIMANT CODE. If the CLAIMANT CODE is adequate to make that structure unique, then that is all that is needed, as illustrated by the follow XML code segment.

```
<Folder>
  <Lookup>
    <Attributes>
      <Attribute>
        <attributeRef valueType=“literal”>Claimant Code</attributeRef>
        <value valueType=“field-ref”>CLAIMANTCODE</value>
    </Attribute>
    </Attributes>
  </Lookup>
</Folder>
```

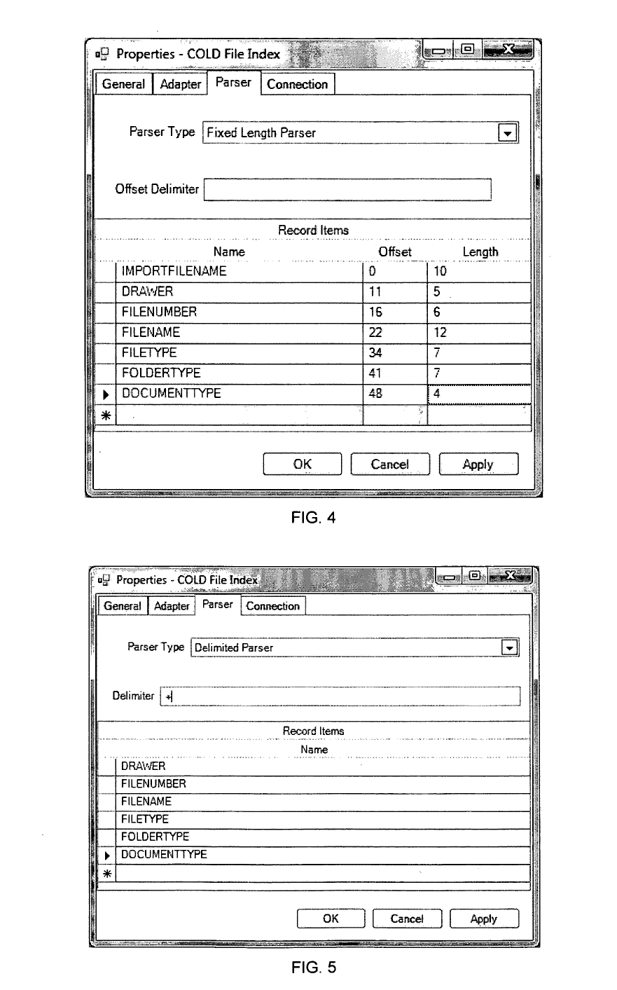

A next step 36 of the exemplary method 31 includes enabling a user via a user interface, for example, to configure import rules of the XML or other template according to the ascertained structural attribute(s) of the unstructured content. Formatting rules within the template are configurable through a user interface, such as provided by an ImageRight Enterprise Management Console, commercially available from Vertafore, Inc. Using the console, the user may specify whether the index file is fixed width or delimited. Fixed width means that the values have an offset or starting position and have a length, such as illustrated in FIG. 4. Delimited means the values are split by a user specified separator, such as illustrated by “CLMS+12345+SmithJohn+Claims+Policy+Endorsement.tif,” as illustrated in FIG. 5. Here, the “+” sign is the delimiter.

Step 38 of the exemplary method includes accessing and examining information components of the unstructured content according to one or more structural attributes. Step 40 includes optionally tagging one or more information records or components of the unstructured content according to a value of the accessed and examined information components. Tagging the content means setting up attributes associated with components of the file structure and setting those values using the template. In addition to the Lookup section noted above, the user may be provided with a section to create or update content information, as illustrated below.

```
<Update>
  <Attributes>
    <Attribute>
      <attributeRef valueType=“literal”>Claimant Code</attributeRef>
      <value valueType=“field-ref”>CLAIMANTCODE</value>
    </Attribute>
  </Attributes>
</Update>
```

The method further includes a step 42 of importing information components of the unstructured content into a repository of the content management system according to indices of the index file.

An index file provides information on where to place the unstructured content into the content management system. Indices of the index file may, for example, identify a location, drawer, file type, file number, folder type and document type, such as illustrated by the following format.

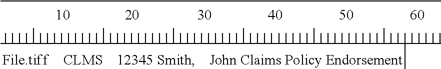

The exemplary method 31 further includes a step 44 of identifying (which includes creating and/or selecting) a workflow task with respect to the imported information components of the imported content; and a step 46 of processing a workflow task of the content document management system relative to the imported content. A workflow simulates a business process of the enterprise. The task proceeds from step to step until it reaches an end of the Workflow or end of the business process. A common example of an automated workflow process would be processing a new application for insurance and a common step within that process would be indexing policy information. Indexing may include associating the new application with an existing policy or creating a new policy.

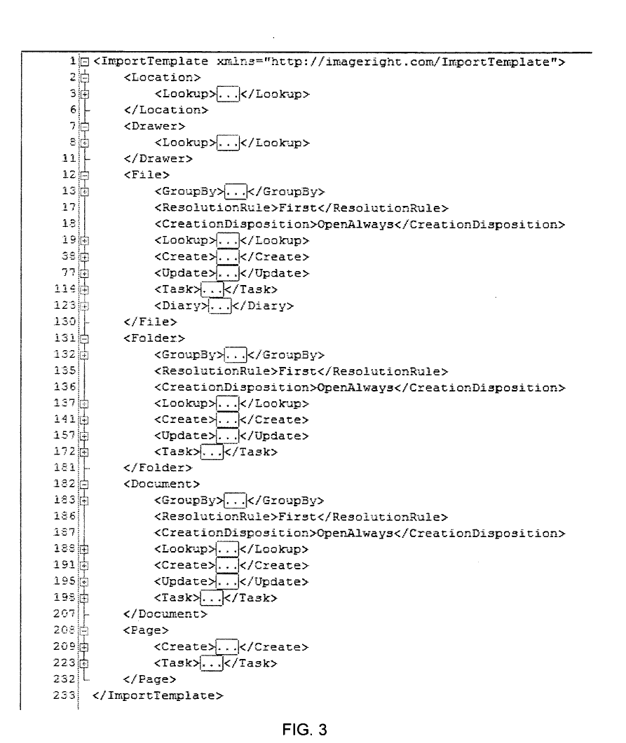

FIG. 3 shows an example of an XML template that defines the importation process. This example demonstrates the flexibility that can be achieved through Universal Imports to import information from complex file structures that cannot be achieved through legacy import schemes.

The Appendix shows an example template that contains the rules for an import process. As noted, the template allows for field referenced, literal, or other values. Literal values can be used if the information does not need to be dynamic for each import file. Field reference values can be configured by the user which may be a list of named fields along with details of where those values reside. The named fields may be referenced from the template which may then be used to retrieve data during the import processing. The following segment of code in the appendix shows an example of literal and field reference value types.

<fileType valueType=“literal”>Claims</fileType>
<number>
<part valueType=“field-ref”>FILENUMBER</part>
</number>|

The literal value in this example will not change unless the administrator changes the template. The field reference value may possibly change during every import record.

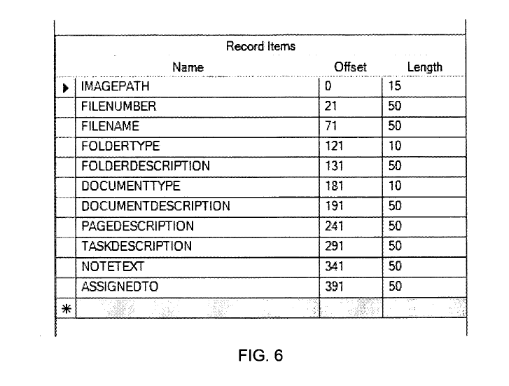

FIG. 6 shows the table of named fields which may be referenced in the template.

The name in the template matches one of the items in the table. The administrator also has the ability to exclude data that was previously required but not needed in the import process. This greatly simplifies the user's creation of the index files along with any future maintenance required for the import process. This example demonstrates the complexity that can be achieved through Universal Imports that cannot be achieved through legacy imports.

Although the invention has been described relative to exemplary hardware and software modules, it is within the skill of the ordinary artisan based on the teachings herein to alter, modify, or rearrange various elements of the apparatus and method without departing from the scope of the invention. According, the invention is defined by the appended claims rather than by what is shown or described herein.

APPENDIX

```
<ImportTemplate xmlns=“http://imageright.com/ImportTemplate”>
  <Location>
    <Lookup>
      <Name valueType=“literal”></Name>
    </Lookup>
  </Location>
  <Drawer>
    <Lookup>
      <Name valueType=“literal”></Name>
    </Lookup>
  </Drawer>
  <File>
        <GroupBy>
```

<Field>FILETYPE</Field>
<Field>FILENUMBER</Field>

```
    </GroupBy>
        <ResolutionRule>First</ResolutionRule>
        <CreationDisposition>OpenAlways</CreationDisposition>
    <Lookup>
      <fileType valueType=“field-ref”>FILETYPE</fileType>
      <number>
        <part valueType=“field-ref”>FILENUMBER</part>
      </number>
      <name valueType=“field-ref”>FILENAME</name>
```

<Marks>

<Mark>

<markRef valueType=“literal”>MARKID</markRef>
<option valueType=“literal”>ADD</option>

</Mark>

</Marks>

<Attributes>

<Attribute>

<attributeRef valueType=“literal”>Claimant Code</attributeRef>
<value valueType=“field-ref”>CLAIMANTCODE</value>

</Attribute>

```
      </Attributes>
    </Lookup>
        <Create>
      <fileType valueType=“field-ref”>FILETYPE</fileType>
      <number>
        <part valueType=“field-ref”>FILENUMBER</part>
      </number>
      <name valueType=“field-ref”>FILENAME</name>
    </Create>
        <Update>
      <name valueType=“field-ref”>NEWFILENAME</name>
    </Update>
        <Task>
```

<Create>

<flowName valueType=“field-ref”>FLOWNAME</flowName>
<stepName valueType=“field-ref”>STEPNAME</stepName>

```
          </Create>
    </Task>
        <Diary>
```

<Create>

<description valueType=“field-ref”>Diary description</description>

```
          </Create>
    </Diary>
  </File>
  <Folder>
        <GroupBy>
```

<Field>FOLDERTYPE</Field>

```
    </GroupBy>
        <ResolutionRule>First</ResolutionRule>
        <CreationDisposition>OpenAlways</CreationDisposition>
    <Lookup>
      <folderType valueType=“field-ref”>FOLDERTYPE</folderType>
    </Lookup>
    <Create>
      <folderType valueType=“field-ref”>FOLDERTYPE</folderType>
      <description valueType=“field-ref”>FOLDERDESCRIPTION</description>
    </Create>
        <Update>
      <folderType valueType=“field-ref”>FOLDERTYPE</folderType>
      <description valueType=“field-ref”>FOLDERDESCRIPTION</description>
    </Update>
        <Task>
```

<Create>

<flowName valueType=“field-ref”>FLOWNAME</flowName>
<stepName valueType=“field-ref”>STEPNAME</stepName>

```
        </Create>
    </Task>
  </Folder>
  <Document>
        <GroupBy>
```

<Field>DOCUMENTTYPE</Field>

```
    </GroupBy>
        <ResolutionRule>First</ResolutionRule>
        <CreationDisposition>OpenAlways</CreationDisposition>
    <Lookup>
      <documentType valueType=“field-ref”>DOCUMENTTYPE</documentType>
    </Lookup>
    <Create>
      <documentType valueType=“field-ref”>DOCUMENTTYPE</documentType>
      <description valueType=“field-ref”>DOCUMENTDESCRIPTION</description>
    </Create>
        <Update>
      <documentType valueType=“field-ref”>DOCUMENTTYPE</documentType>
      <description valueType=“field-ref”>DOCUMENTDESCRIPTION</description>
    </Update>
        <Task>
```

<Create>

<flowName valueType=“field-ref”>FLOWNAME</flowName>
<stepName valueType=“field-ref”>STEPNAME</stepName>

```
        </Create>
    </Task>
  </Document>
  <Page>
    <Create>
      <description valueType=“field-ref”>PAGEDESCRIPTION</description>
      <image valueType=“field-ref”>IMPORTFILENAME</image>
    </Create>
        <Task>
```

<Create>

<flowName valueType=“field-ref”>FLOWNAME</flowName>
<stepName valueType=“field-ref”>STEPNAME</stepName>

```
        </Create>
    </Task>
  </Page>
</ImportTemplate>
```

We claim:

1. In a content management system having a repository of information organized according to an index file, the improvement comprising a method of importing unstructured content into said repository comprising:
providing a template of configurable import rules to enable retrieval of information components of said unstructured content,
ascertaining at least one structural attribute of said unstructured content,
enabling a user to configure import rules of said template according to the ascertained structural attribute,
accessing and examining information components of said unstructured content according to said attribute,
optionally tagging information components of said unstructured content according to a value of the accessed and examined information components,
importing information components of the unstructured content into said repository of the content management system according to indices of said index file,
identifying a workflow task with respect to the information components of the imported content, and
processing said workflow task of said content management system relative to said imported content.

2. The improvement of claim 1, further including the step of associating information components of said unstructured content with respective indices of said index file prior to importing components of said unstructured content into said repository.

3. The improvement of claim 1, wherein said template resides in xml format.

4. The improvement of claim 1 wherein the indices of said index file define a location, drawer, file type, file number, folder type, and a document type.

5. The improvement of claim 1, further including the step of enabling the user to configure the index file to modify the indices thereof and thereby alter the structure of said repository.

6. The improvement of claim 1 wherein the step of ascertaining a structural attribute of said unstructured content comprises examining fields and/or delimiters of data records or fields of said unstructured content.

7. The improvement of claim 1, wherein said optionally tagging step includes tagging said information records according to a field reference value or literal value of the accessed and examined information components.

8. The improvement of claim 1, further comprising, after the importing step, iteratively modifying said template and importing said unstructured content according to information derived by a prior importing step.

9. In a content management system, a method of importing unstructured content comprising:
establishing indexing criteria for use in the content management system wherein said indexing criteria are defined to support a workflow processing scheme;
examining the unstructured content to determine a preliminary file structure;
providing a template of user-configurable import rules;
configuring said import rules of said template according to said preliminary file structure of the unstructured content;
importing said content into the content management system according to said import rules; and
performing a workflow task with respect to the imported content.

10. The method of claim 9, further comprising:
after said importing step, determining a further file structure of said unstructured content according to information derived from said importing step,
reconfiguring import rules of said template according to said determining step; and
iteratively importing said content into said document management system according to said reconfigured import rules whereby to provide structural enhancement of said unstructured content when imported into said content management system.

11. The method of claim 9, further comprising steps of:
providing a record for each page in a records database used to store retrieve pages of information of said unstructured content, and
indexing each page of said imported content to provide a reference useful to retrieve each said page in the content management system.

12. A content management system useful for importing unstructured content, said system comprising:
a template of configurable import rules,
a user interface module to provide a user interface that enables a user to configure said template,
a repository to store information,
a retrieval module to access and retrieve information components from a storage medium containing said unstructured content, said accessing and retrieval being performed according to said template of configurable import rules,
an indexing module responsive to the retrieval module to store information components of said unstructured content in said repository according to indices of an index file, and
a workflow processing module that accesses said repository to process information components of said imported, unstructured content.

13. The content management system of claim 12, further comprising:
a tagging module responsive to said retrieval module to tag respective information components of said unstructured content according to a value thereof, wherein said indexing module effects storage of said components in said repository according to said tag.

14. The content management system of claim 13, wherein said information components are tagged according to a field reference value or a literal value

15. The content management system of claim 12, wherein said retrieval module retrieves information components of said unstructured content according to a data field of a record and/or a delimiter of said unstructured content.

16. The content management system of claim 12, wherein the indices of said index file of the indexing module effects storage of information components of said unstructured content according to location, file type, file number, folder type, or a document type.

17. The content management system of claim 12, wherein said user interface module enables the user to iteratively reconfigure the import rules of said template based on a nature or character of imported records of said unstructured content.

18. The content management system of claim 12, wherein said user interface module enables the user to reconfigure indices of said index file in order to alter the structure of the repository in which information components of said unstructured content are stored.
